(19) United States
(12) Patent Application Publication
(10) Pub. No.: US 2016/0369848 A1
(43) Pub. Date: Dec. 22, 2016

(54) SLIDING CONSTANT-VELOCITY JOINT

(71) Applicant: JTEKT CORPORATION, Osaka-shi (JP)

(72) Inventor: Keishi KOBATA, Anjo-shi (JP)

(73) Assignee: JTEKT CORPORATION, Osaka-shi (JP)

(21) Appl. No.: 15/180,652

(22) Filed: Jun. 13, 2016

(30) Foreign Application Priority Data
Jun. 18, 2015 (JP) 2015-122962

(51) Int. Cl. F16D 3/205

(52) U.S. Cl. CPC F16D 3/2055; F16D 2003/2023

(57) ABSTRACT

A sliding constant-velocity joint includes: an outer ring, in the inner surface of which a plurality of raceway grooves are formed; a tripod member that transfers torque between the outer ring and a shaft; an intermediate member that swingably supports a tripod shaft portion of the tripod member; a plurality of rolling elements that can roll along the outer surface of the intermediate member; and a cage that holds the rolling elements. The amount of movement of the intermediate member in a radial direction of the outer ring is restrained such that the intermediate member does not contact a neck portion of the tripod shaft portion or a boss portion because of tilt motion of the intermediate member caused along with swing motion of the tripod shaft portion during rotation of the outer ring and the shaft.

### INCORPORATION BY REFERENCE

The disclosure of Japanese Patent Application No. 2015-122962 filed on Jun. 18, 2015 including the specification, drawings and abstract, is incorporated herein by reference in its entirety.

### BACKGROUND OF THE INVENTION

1. Field of the Invention

The present invention relates to a sliding constant-velocity joint.

2. Description of Related Art

There has hitherto been known a constant-velocity joint disposed between a side gear that serves as an output member of a differential device of a vehicle and an intermediate shaft of a drive shaft to enable a shaft for the side gear and the intermediate shaft to always rotate at an equal speed even if an angle formed between the two shafts is varied.

Examples of such a constant-velocity joint include a sliding constant-velocity joint that includes: an outer ring formed in a bottomed cylindrical shape and provided with three housing portions formed in the inner peripheral surface to extend in the center axis direction; a tripod member that has three tripod shaft portions housed in the three housing portions of the outer ring; and a roller unit disposed between a pair of raceway grooves formed in the housing portion of the outer ring to face each other and the tripod shaft portion (see Japanese Patent Application Publication No. 2010-7701 (JP 2010-7701 A), for example).

The roller unit of the sliding constant-velocity joint described in JP 2010-7701 A has an intermediate member that supports the tripod shaft portion so as to be swingable when the intermediate shaft is at a joint angle, a plurality of rolling elements disposed so as to be rollable along the outer surface of the intermediate member, and a cage that holds the plurality of rolling elements, and is disposed so as to be slidable along the pair of raceway grooves of the outer ring. The cage is composed of a pair of circulation path forming members coupled opposite to each other so as to hold both end portions of the plurality of rolling elements in the axial direction. The joint angle refers to the angle formed between the center axis of the outer ring which serves as an input shaft and the center axis of the intermediate shaft which serves as an output shaft.

The tripod shaft portion has a head portion with an outer peripheral surface formed in a convex spherical shape, and a neck portion that is formed between the head portion and a boss portion and that is smaller in outside diameter than the head portion. The inner surface of the intermediate member is formed such that an abutment surface that abuts against the head portion of the tripod shaft portion has a concave spherical shape corresponding to the outer peripheral surface of the head portion. Consequently, relative movement between the tripod shaft portion and the intermediate member in the radial direction of the outer ring is restrained. The pair of raceway grooves of the outer ring are each provided with an engagement protrusion formed along the direction of extension of the raceway groove to project so as to narrow the width of the raceway groove in the radial direction of the outer ring. The cage is configured to be positioned in the pair of raceway grooves by the engagement protrusion.

In the sliding constant-velocity joint configured as described above, when the intermediate shaft and the outer ring are rotated with a joint angle applied (with the intermediate shaft tilted with respect to the outer ring), the tripod member is rotated eccentrically with respect to the rotational axis of the outer ring as seen along the rotational axis of the outer ring, and therefore the tripod shaft portion makes advancing and retracting motion in the radial direction of the outer ring together with the intermediate member. As the joint angle is larger, the amount of eccentricity of the tripod member with respect to the outer ring is increased, which increases the advancing and retracting motion of the tripod shaft portion described above.

In the sliding constant-velocity joint described in JP 2010-7701 A, when the intermediate shaft and the outer ring are rotated with the joint angle maximized, for example, the lower end of the intermediate member on the inner side in the radial direction of the outer ring and the neck portion of the tripod shaft portion interfere with each other along with tilt motion of the tripod member, and the intermediate member is also tilted with respect to the outer ring as the intermediate member receives a load along with the tilt motion of the tripod shaft portion.

The outer surface of the intermediate member then contacts the cage, which also urges the cage to be tilted together with the intermediate member. In this event, the cage may be deformed in the case where a load received from the intermediate member is large, because the position of the cage with respect to the outer ring is restrained by the engagement protrusion in the raceway groove of the outer ring. Therefore, it is necessary to secure the strength of the cage by increasing the thickness of the pair of circulation path forming members, for example, which hinders a reduction in size and weight of the sliding constant-velocity joint and a cost reduction.

### SUMMARY OF THE INVENTION

It is an object of the present invention to provide a sliding constant-velocity joint that can suppress transfer of a load to a cage when the joint angle is maximized.

According to an aspect of the present invention, a sliding constant-velocity joint includes: an outer member formed in a tubular shape and having an inner peripheral surface in which a plurality of raceway grooves having a pair of raceway surfaces that extend in a center axis direction and face each other are formed; an inner member having an annular boss portion coupled to an end portion of a shaft that is rotatable at a predetermined joint angle with respect to the outer member, and a plurality of leg shafts that extend from an outer surface of the boss portion to be inserted into the raceway grooves, the inner member transferring torque between the shaft and the outer member; an intermediate member disposed between each leg shaft and the pair of raceway surfaces to swingably support the leg shaft; a plurality of rolling elements disposed between the pair of raceway surfaces and the intermediate member and having a circular columnar barrel portion; and a cage that holds the plurality of rolling elements such that the rolling elements can circulate along an outer surface of the intermediate member, in which: the leg shaft has a head portion that contacts an inner surface of the intermediate member, and a neck portion formed to be smaller in diameter than the head portion and configured to couple the head portion and the boss portion to each other; and an amount of movement of the intermediate member in a radial direction of the outer member is restrained such that the intermediate member is not tilted by contact between the intermediate member and the neck portion or the boss portion caused along with swing motion of the leg shaft during rotation of the outer member and the shaft.

According to the present invention, it is possible to suppress transfer of a load to a cage when the joint angle is maximized.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is an overall view illustrating a sliding constant-velocity joint according to an embodiment as partially cut away;

FIG. 2 is a plan view of an outer ring of the sliding constant-velocity joint as seen in the rotational axis direction of the outer ring;

FIG. 3 is an exploded perspective view illustrating a tripod member together with a roller unit;

FIG. 4 is a front view illustrating the roller unit;

FIG. 5A is a sectional view taken along the line A-A of FIG. 4;

FIG. 5B is a sectional view taken along the line B-B of FIG. 4;

FIG. 6A is a view schematically illustrating rolling elements, a cage, and the tripod member disposed between a pair of raceway grooves in the outer ring, illustrating a state in which the joint angle is 0°; and

FIG. 6B is a view schematically illustrating the rolling elements, the cage, and the tripod member disposed between the pair of raceway grooves in the outer ring, illustrating a state in which the joint angle is maximized.

### DETAILED DESCRIPTION OF EMBODIMENTS

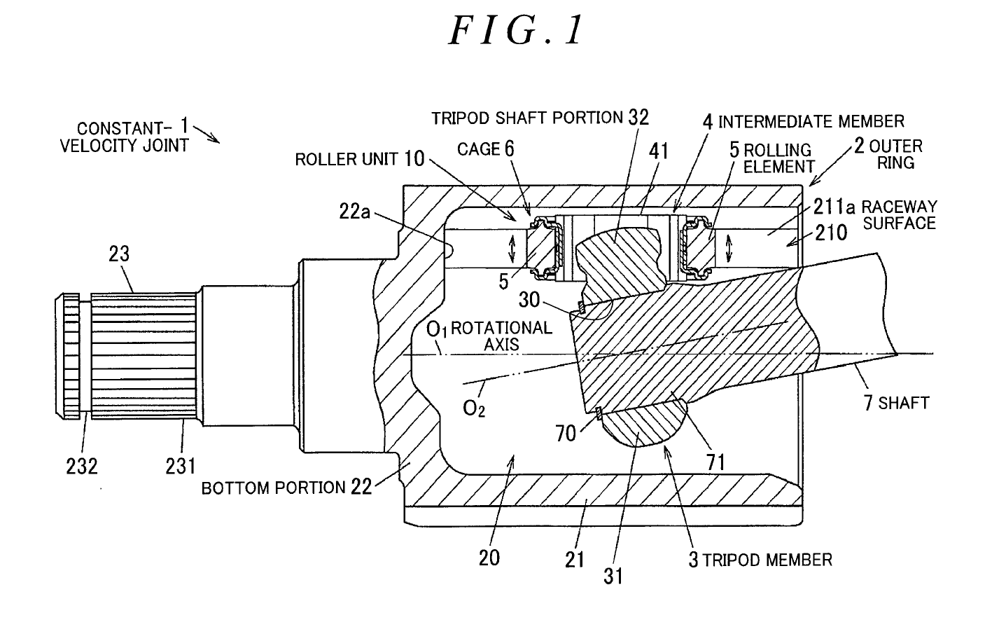

A sliding constant-velocity joint according to an embodiment of the present invention will be described below with reference to FIGS. 1 to 6B.

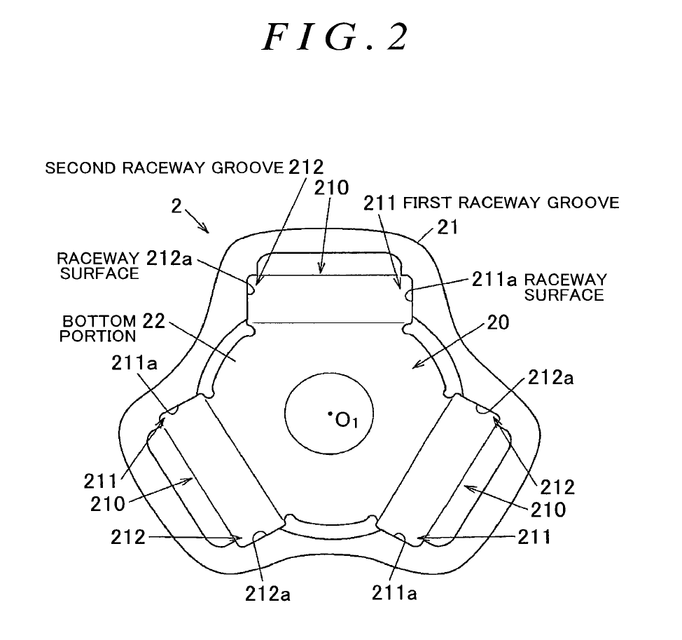

FIG. 1 is an overall view illustrating a sliding constant-velocity joint according to the embodiment as partially cut away. FIG. 2 is a plan view of an outer ring of the sliding constant-velocity joint as seen in the direction of a rotational axis (center axis) O₁ of the outer ring. Hereinafter, the sliding constant-velocity joint will be referred to simply as a constant-velocity joint.

A constant-velocity joint 1 is disposed between a side gear (not illustrated) that serves as an output member of a differential device of a vehicle and a shaft (an intermediate shaft of a drive shaft) 7, and transfers a drive force for rotating the wheels to the shaft 7. The constant-velocity joint 1 is also referred to as a tripod constant-velocity joint, and has an outer ring 2 that serves as an outer member, a tripod member 3 that serves as an inner member, and three roller units 10 (only one roller unit 10 is illustrated in FIG. 1). The outer ring 2 is coupled so as to rotate together with the side gear of the differential device. The tripod member 3 is coupled so as to rotate together with the shaft 7 which rotates at a predetermined joint angle. The roller units 10 are fitted with tripod shaft portions 32 that serve as leg shafts of the tripod member 3 to be discussed later. The configuration of such members will be described in detail below.

The outer ring 2 has: a tubular portion 21 which extends in the center axis direction and in the inner surface of which a plurality of (three) housing portions 210 configured to house the roller units 10 are formed; a bottom portion 22 that blocks one end portion of the tubular portion 21; and a stem portion 23 in the shape of a shaft that projects from the center portion of the bottom portion 22 away from the tubular portion 21. The tubular portion 21 and the bottom portion 22 are integrated with each other to provide a bottomed cylindrical shape. A housing space 20 configured to house the tripod member 3 and the three roller units 10 is formed inside the tubular portion 21. The center axis of the tubular portion 21 coincides with the rotational axis O₁ of the outer ring 2. FIG. 1 illustrates a state in which a rotational axis O₂ of the tripod member 3 is tilted with respect to the rotational axis O₁ of the outer ring 2 with the joint angle set to a predetermined angle. Hereinafter, the direction which is parallel to the center axis of the tubular portion 21 (the rotational axis O₁ of the outer ring 2) will be referred to as the center axis direction of the outer ring 2.

As illustrated in FIG. 2, the three housing portions 210 are disposed at equal intervals along the circumferential direction of the tubular portion 21. Each housing portion 210 is provided with first and second raceway grooves 211 and 212 formed to be dented outward from the center portion of the tubular portion 21. The three roller units 10 are housed in the three housing portions 210, respectively. Raceway surfaces 211a and 212a, on which the roller unit 10 slides, are formed on the groove bottom of the first and second raceway grooves 211 and 212. The first and second raceway surfaces 211a and 212a are flat surfaces, and face and extend in parallel with each other.

The bottom portion 22 is provided with a flat bottom surface 22a which extends orthogonally to the direction of extension of the housing portions 210 and against which rolling elements 5 of the roller units 10 abut when the tripod member 3 is moved to the deeper side of the housing space 20 of the tubular portion 21.

The stem portion 23 is provided with a spline fitting portion 231 formed to be spline-fitted with the side gear of the differential device. In addition, an annular groove 232 configured to hold a ring-shaped retainer (not illustrated) such as a snap ring is formed at an end portion of the stem portion 23 on the distal end side (on the side opposite to the base end side which is near the bottom portion 22) with respect to the spline fitting portion 231.

The roller units 10 each include: an intermediate member 4 composed of first and second split members 41 and 42 (only the first split member 41 is illustrated in FIG. 1) to be discussed later; the rolling elements 5 disposed on the outer peripheral side of the intermediate member 4; and a cage 6 that holds the rolling elements 5.

The tripod member 3 is an annular member formed from the tripod shaft portions 32 discussed earlier and a boss portion 31 that forms a body of the tripod member 3. An insertion hole 30 that allows insertion of the shaft 7 is formed in the boss portion 31 of the tripod member 3, and a spline fitting portion 71 formed at an end portion of the shaft 7 is fitted in the insertion hole 30 so as not to be relatively rotatable. The tripod member 3 is retained by a snap ring 70 fitted with the shaft 7.

The tripod member 3 is movable within a predetermined movable range with respect to the outer ring 2 along the center axis direction of the outer ring 2. When the constant-velocity joint 1 is assembled to the differential device of the vehicle, the tripod member 3 is pushed toward the bottom portion 22 of the outer ring 2 (in the direction of the arrow indicated in FIG. 1) via the shaft 7. Movement of the tripod member 3 toward the bottom portion 22 of the outer ring 2 is restrained with the rolling elements 5 of the roller unit 10 abutting against the bottom surface 22a.

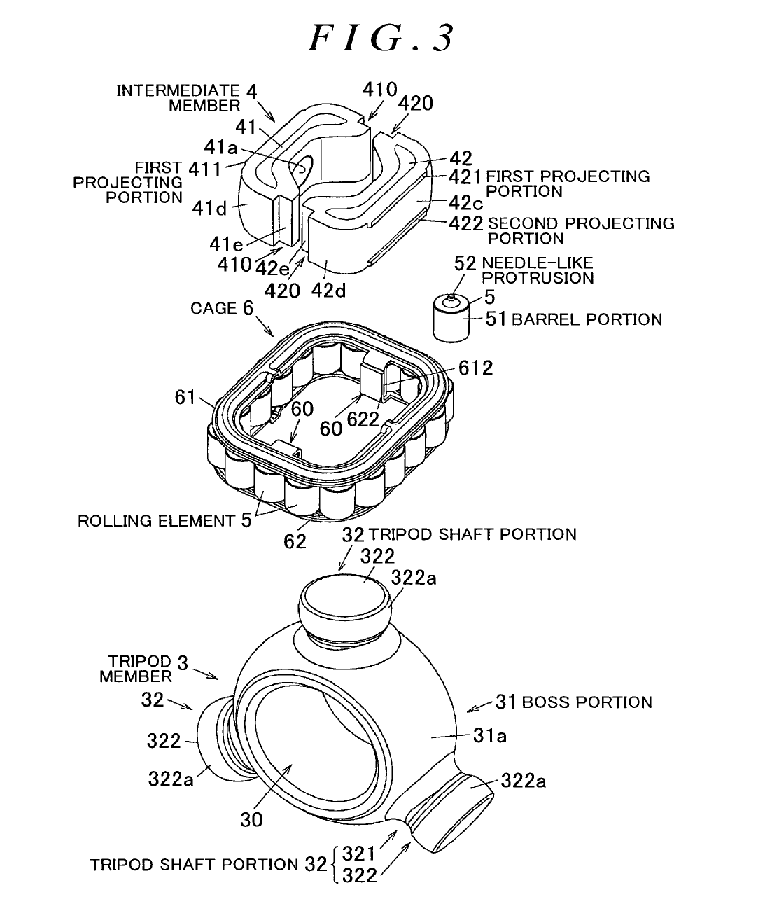

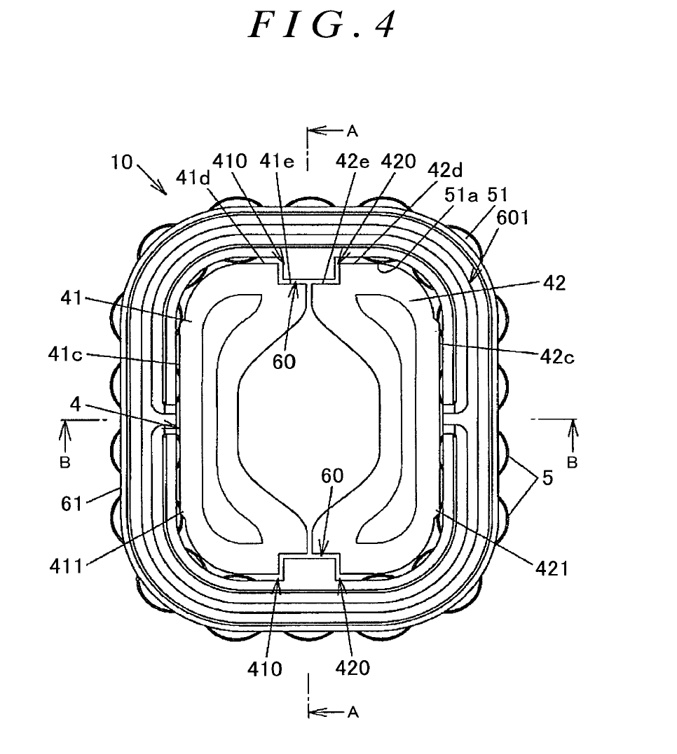

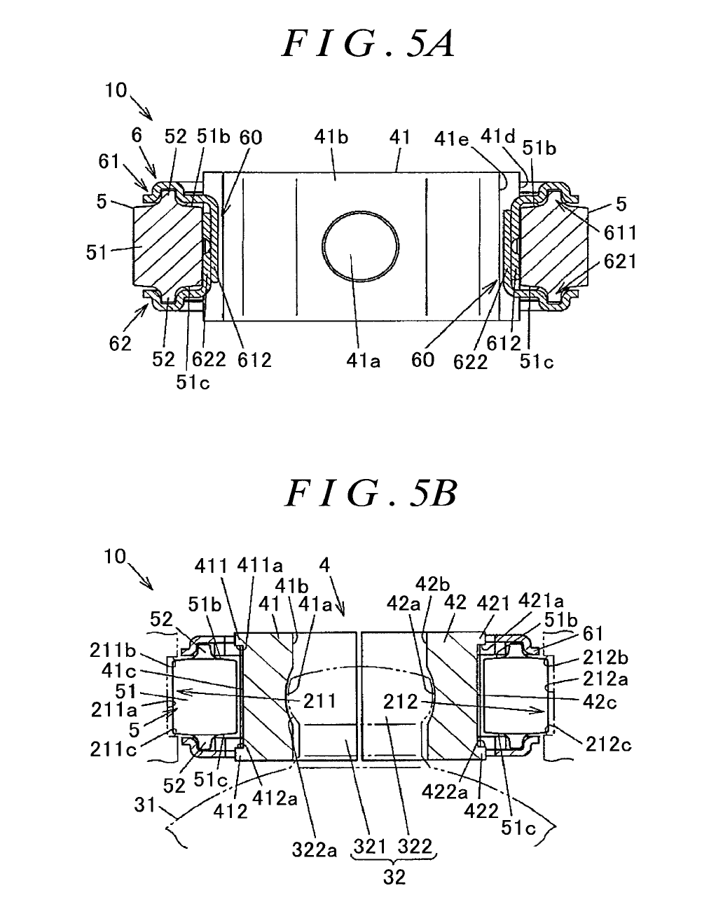

FIG. 3 is an exploded perspective view illustrating the tripod member 3 together with the roller unit 10 which is combined with one of the tripod shaft portions 32. FIG. 4 is a front view illustrating the roller unit 10. FIG. 5A is a sectional view taken along the line A-A of FIG. 4. FIG. 5B is a sectional view taken along the line B-B of FIG. 4. In FIG. 5B, the tripod shaft portion 32 of the tripod member 3 and the raceway surfaces 211a and 212a of the first raceway groove 211 and the second raceway groove 212 of the outer ring 2 are indicated by the long dashed double-short dashed lines.

The roller unit 10 includes: the intermediate member 4 which is composed of the pair of split members 41 and 42 which are disposed separately so as to interpose a head portion 322 of the tripod shaft portion 32; the plurality of rolling elements 5 which roll on one of the raceway surfaces 211a and 212a of the first raceway groove 211 and the second raceway groove 212 (illustrated in FIG. 2) in accordance with the rotational direction of the outer ring 2 and the direction of torque transfer between the outer ring 2 and the shaft 7; and the cage 6 that holds the rolling elements 5 so as to be able to circulate on the outer peripheral side of the intermediate member 4.

As illustrated in FIG. 3, the tripod member 3 has: the annular boss portion 31; and the plurality of (three) tripod shaft portions 32 which are provided to extend outward in the radial direction of the boss portion 31 from an outer peripheral surface 31a of the boss portion 31 to be inserted into the raceway grooves 211 of the outer ring 2 (illustrated in FIG. 2). A plurality of spline protrusions to be fitted with the spline fitting portion 71 of the shaft 7 (illustrated in FIG. 1) are formed on the inner peripheral surface of the insertion hole 30 of the boss portion 31. In FIG. 3, however, the spline protrusions are not illustrated.

The three tripod shaft portions 32 are provided at equal intervals along the circumferential direction of the boss portion 31. The distal end portions of the tripod shaft portions 32 are formed to be partially spherical. More specifically, the tripod shaft portions 32 each have a neck portion 321 on the boss portion 31 side, and the head portion 322 which has the outer peripheral surface 322a in a convex spherical shape that is larger in outside diameter than the neck portion 321. The head portion 322 is provided closer to the distal end of the tripod shaft portion 32 than the neck portion 321. The roller unit 10 is swingably fitted with the head portion 322 of each of the three tripod shaft portions 32.

The intermediate member 4 is interposed between the tripod shaft portion 32 and the rolling elements 5. One of the split members 41 (which is hereinafter referred to as a first split member 41) is disposed between the tripod shaft portion 32 and the raceway surface 211a of the first raceway groove 211 (illustrated in FIG. 2). The other of the split members 42 (which is hereinafter referred to as a second split member 42) is disposed between the tripod shaft portion 32 and the raceway surface 212a of the second raceway groove 212 (illustrated in FIG. 2). The first split member 41 and the second split member 42 are formed to be shaped symmetrically.

The first and second split members 41 and 42 are provided with concave surfaces 41a and 42a (only the concave surface 41a of the first split member 41 is illustrated in FIG. 3), respectively, formed in a partially spherical shape and contacted by the outer peripheral surface 322a of the head portion 322 of the tripod shaft portion 32. Consequently, the head portion 322 of the tripod shaft portion 32 is swingable with respect to the intermediate member 4.

The surfaces of the first and second split members 41 and 42 on the side opposite to the concave surfaces 41a and 42a are formed as flat rolling surfaces 41c and 42c (only the rolling surface 42c of the second split member 42 is illustrated in FIG. 3) on which the rolling elements 5 roll.

The rolling surface 41c of the first split member 41 is provided with first and second projecting portions 411 and 412 (only the first projecting portion 411 is illustrated for the first split member 41 illustrated in FIG. 3) formed to project in the direction opposite to the concave surface 41a. The first projecting portion 411 projects from a portion of the rolling surface 41c on the upper end side in the direction orthogonal to the longitudinal direction, and extends in parallel with the raceway surface 211a of the first raceway groove 211. The second projecting portion 412 projects from a portion of the rolling surface 41c on the lower end side in the direction orthogonal to the longitudinal direction, and extends in parallel with the raceway surface 212a of the second raceway groove 212. The second split member 42 is configured similarly.

The first and second split members 41 and 42 are provided with notches 410 and 420, respectively, formed so as to avoid interference with coupling portions 60 of the cage 6 to be discussed later. Consequently, the end surfaces of the first and second split members 41 and 42 in the center axis direction of the outer ring 2 are constituted of first end surfaces 41d and 42d at portions at which the notches 410 and 420 are not formed, and second end surfaces 41e and 42e provided in the notches 410 and 420, respectively.

The rolling elements 5 are each formed in the shape of a shaft that includes a circular columnar barrel portion 51 and a pair of needle-like protrusions 52 provided to extend from both end surfaces of the barrel portion 51 in the axial direction of the rolling element 5. In the embodiment, 18 rolling elements 5 are disposed on the outer circumference of the intermediate member 4. It should be noted, however, that the number of the rolling elements 5 is changeable as appropriate in accordance with the torque transfer capacity of the constant-velocity joint 1 or the like. In FIG. 3, one of the rolling elements 5 is illustrated outside the cage 6.

When the vehicle on which the constant-velocity joint 1 is mounted accelerates while traveling forward, the rolling elements 5 roll on the raceway surface 211a of the first raceway groove 211 to transfer torque between the outer ring 2 and the first split member 41. When the vehicle decelerates while traveling forward or accelerates while traveling rearward, on the other hand, the rolling elements 5 roll on the raceway surface 212a of the second raceway groove 212 to transfer torque between the outer ring 2 and the second split member 42.

The cage 6 is constituted by coupling a pair of circulation path forming members 61 and 62 to each other to interpose the rolling elements 5 in the axial direction thereof, and provides a rectangular shape with rounded corners as viewed in a front view from the radial direction of the outer ring 2 (see FIG. 4 to be discussed later). In the following description, one of the circulation path forming members 61 and 62 disposed on the radially outer side farther from the rotational axis O₁ in the housing space 20 of the outer ring 2 is referred to as a first circulation path forming member 61, and the other circulation path forming member is referred to as a second circulation path forming member 62. The first circulation path forming member 61 and the second circulation path forming member 62 are shaped by pressing a plate material made of metal.

In the cage 6, the first circulation path forming member 61 and the second circulation path forming member 62 are coupled to each other by a pair of coupling portions 60. The coupling portions 60 are provided on the inner side (on the tripod shaft portion 32 side) with respect to the raceway along which the rolling elements 5 circulate, and arranged along the center axis direction of the tubular portion 21.

The coupling portions 60 of the cage 6 are each formed by superposing a first coupling piece 612 formed on the first circulation path forming member 61 and a second coupling piece 622 formed on the second circulation path forming member 62 on each other, and coupling the first coupling piece 612 and the second coupling piece 622 to each other. In the embodiment, the first coupling piece 612 and the second coupling piece 622 are coupled to each other by caulking. However, the present invention is not limited thereto, and the first coupling piece 612 and the second coupling piece 622 may be coupled by each other by welding, for example.

As illustrated in FIG. 4, the first end surface 41d of the first split member 41 contacts outer peripheral surfaces 51a of the barrel portions 51 of the rolling elements 5, and the second end surface 41e opposes the coupling portion 60 of the cage 6 via a clearance. Consequently, when the tripod member 3 is pushed toward the bottom portion 22 of the outer ring 2, so that the barrel portions 51 of the rolling elements 5 contact the bottom surface 22a during assembly of the constant-velocity joint 1 to the differential device, for example, the first end surfaces 41d and 42d of the first and second split members 41 and 42 contact the barrel portions 51 of the rolling elements 5, but a clearance is formed between the second end surfaces 41e and 42e and the coupling portion 60 of the cage 6 so that a pressing force in the center axis direction is not transferred to the cage 6.

As illustrated in FIG. 5A, the first circulation path forming member 61 is provided with a first recessed groove 611 formed so as to guide a first needle-like protrusion 52, of the pair of needle-like protrusions 52 of the rolling elements 5. Meanwhile, the second circulation path forming member 62 is provided with a second recessed groove 621 formed so as to guide a second needle-like protrusion 52, of the pair of needle-like protrusions 52 of the rolling elements 5. The first recessed groove 611 has a U-shape in which the groove bottom is dented away from the second circulation path forming member 62. The second recessed groove 621 has a U-shape in which the groove bottom is dented away from the first circulation path forming member 61.

Of both the end surfaces of the barrel portion 51 of the rolling element 5, a first axial end surface 51b opposes the first circulation path forming member 61, and a second axial end surface 51c opposes the second circulation path forming member 62.

As illustrated in FIG. 5B, the concave surfaces 41a and 42a discussed earlier are formed on the first split member 41 and the second split member 42, respectively. A flat surface 41b of the first split member 41 and a flat surface 42b of the second split member 42 are formed at the outer periphery of the concave surfaces 41a and 42a, respectively such that the flat surface 41b is across the head portion 322 of the tripod shaft portion 32 from the flat surface 42b. The concave surface 41a of the first split member 41 is dented toward the first raceway surface 211a. The concave surface 42a of the second split member 42 is dented toward the second raceway surface 212a.

The rolling surface 41c of the first split member 41 is across the rolling elements 5 from the raceway surface 211a of the first raceway groove 211 of the outer ring 2. The rolling surface 42c of the second split member 42 is across the rolling elements 5 from the raceway surface 212a of the second raceway groove 212 of the outer ring 2.

The inner surface of the first raceway groove 211 is constituted of: the raceway surface 211a on which the rolling elements 5 roll; an outer side surface 211b formed on the outer side with respect to the raceway surface 211a in the radial direction of the outer ring 2; and an inner side surface 211c formed on the inner side in the radial direction of the outer ring 2. The outer side surface 211b is across the barrel portions 51 of the rolling elements 5 from the inner side surface 211c in the radial direction of the outer ring 2.

Similarly, the inner surface of the second raceway groove 212 is constituted of: the raceway surface 212a on which the rolling elements 5 roll; an outer side surface 212b formed on the outer side with respect to the raceway surface 212a in the radial direction of the outer ring 2; and an inner side surface 212c formed on the inner side in the radial direction of the outer ring 2. The outer side surface 212b is across the barrel portions 51 of the rolling elements 5 from the inner side surface 212c in the radial direction of the outer ring 2.

A part of the barrel portions 51 of the rolling elements 5 is disposed between the first projecting portion 411 and the second projecting portion 412 of the first split member 41. A surface of the first projecting portion 411 directed to the rolling elements 5 is formed as an opposing surface 411a that opposes the axial end surfaces 51b of the barrel portions 51 of the rolling elements 5. Similarly, a surface of the second projecting portion 412 directed to the rolling elements 5 is formed as an opposing surface 412a that opposes the axial end surfaces 51c of the barrel portions 51 of the rolling elements 5. The second split member 42 is configured similarly.

The amount of projection of the first projecting portion 411 from the rolling surface 41c in the first split member 41 may be determined such that the opposing surface 411a of the first projecting portion 411 may contact the axial end surfaces 51b of the barrel portions 51 of the rolling elements 5 when the first split member 41 has been moved inward in the radial direction of the outer ring 2 (downward in FIGS. 5A and 5B) with a slight clearance formed between the outer peripheral surfaces 51a of the barrel portions 51 and the rolling surface 41c of the first split member 41 at least during torque transfer between the outer ring 2 and the second split member 42.

Similarly, the amount of projection of the second projecting portion 412 from the rolling surface 41c in the first split member 41 may be determined such that the opposing surface 412a of the second projecting portion 412 may contact the axial end surfaces 51c of the barrel portions 51 of the rolling elements 5 when the second split member 42 has been moved outward in the radial direction of the outer ring 2 (upward in FIGS. 5A and 5B) with a slight clearance formed between the outer peripheral surfaces 51a of the barrel portions 51 and the rolling surface 42c of the second split member 42 at least during torque transfer between the outer ring 2 and the second split member 42. The amount of projection of the first and second projecting portions 421 and 422 of the second split member 42 may be determined in the same manner as described above for the first and second projecting portions 411 and 412 of the first split member 41.

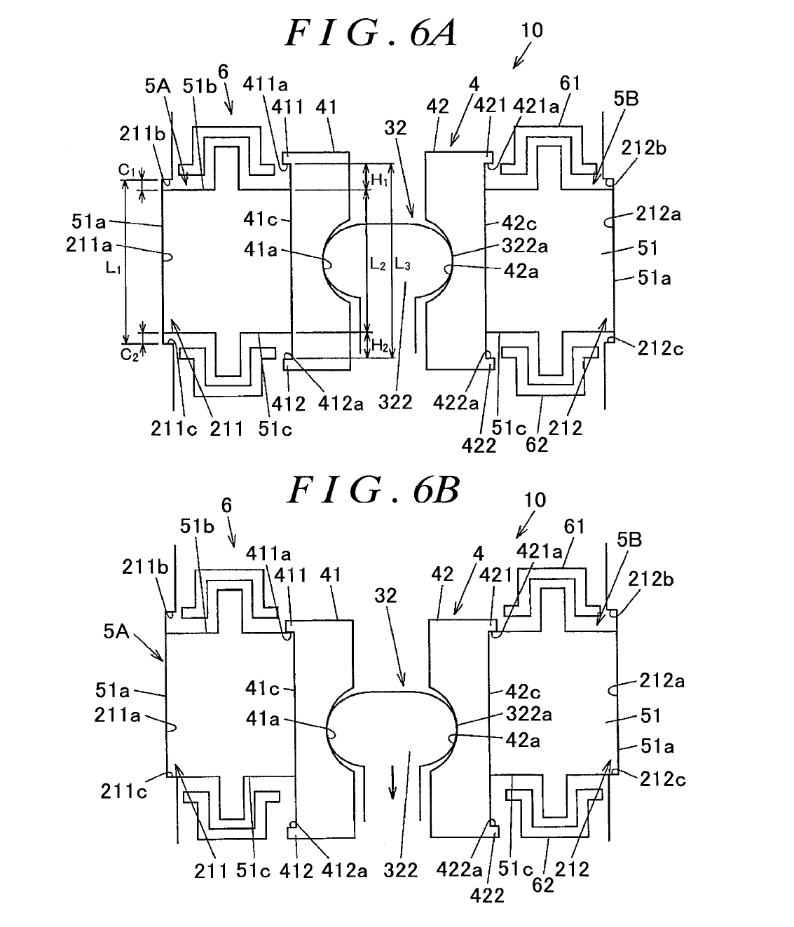

Next, operation with a joint angle during torque transfer of the constant-velocity joint 1 configured as described above with reference to FIGS. 1 to 5B will be described with reference to FIGS. 6A and 6B. FIGS. 6A and 6B schematically illustrate the roller unit 10 and the tripod shaft portion 32 as seen along the sectional view of FIG. 5A at the time when torque is transferred between the outer ring 2 and the tripod member 3. FIG. 6A illustrates a state of the tripod shaft portion 32 and the roller unit 10 at the time when the joint angle is 0°. FIG. 6B illustrates a state of the tripod shaft portion 32 and the roller unit 10 at the time when the joint angle is maximized.

For FIGS. 6A and 6B, for convenience of description, the direction from the outer side toward the inner side in the radial direction of the outer ring 2 (the downward direction in FIGS. 6A and 6B) is referred to simply as the downward direction, and the direction from the inner side toward the outer side in the radial direction of the outer ring 2 is referred to simply as the upward direction.

For FIGS. 6A and 6B, furthermore, the rolling element 5 which rolls adjacent to the raceway surface 211a of the first raceway groove 211 is referred to as a first rolling element 5A, and the rolling element 5 which rolls adjacent to the raceway surface 212a of the second raceway groove 212 is referred to as a second rolling element 5B. It should be noted, however, that the first rolling element 5A and the second rolling element 5B are disposed symmetrically in the up-down direction and the right-left direction in FIGS. 6A and 6B. In the following description, description will be made of the first rolling element 5A, the first raceway groove 211, and the first split member 41, and description of the second rolling element 5B, the second raceway groove 212, and the second split member 42 will be omitted.

In the state illustrated in FIG. 6A in which the joint angle is 0°, the outer ring 2 and the tripod member 3 are not rotated eccentrically, and therefore the tripod shaft portion 32 of the tripod member 3 is not moved in the up-down direction with respect to the first and second raceway grooves 211 and 212 of the outer ring 2.

The outer peripheral surface 322a of the head portion 322 of the tripod shaft portion 32 is fitted with the concave surface 41a of the first split member 41 to spherically contact the concave surface 41a, and therefore relative movement between the tripod shaft portion 32 and the first and second split members 41 and 42 in the up-down direction is restrained. The rolling surface 41c of the first split member 41 contacts the outer peripheral surface 51a of the barrel portion 51 of the first rolling element 5A, and the raceway surface 211a of the first raceway groove 211 contacts the outer peripheral surface 51a of the barrel portion 51 of the first rolling element 5A.

The barrel portion 51 of the first rolling element 5A is positioned at the center portion between the first projecting portion 411 and the second projecting portion 412 of the first split member 41, and positioned at the center portion between the inner side surface 211c and the outer side surface 211b of the first raceway groove 211.

The clearance between the first axial end surface 51b of the barrel portion 51 of the first rolling element 5A and the outer side surface 211b of the first raceway surface 211a is defined as C₁, and the clearance between the second axial end surface 51c of the first rolling element 5A and the inner side surface 211c is defined as C₂. Since the first rolling element 5A is positioned at the center portion in the first raceway groove 211 as discussed earlier, the clearance C₁ and the clearance C₂ are equal to each other (C₁=C₂).

Similarly, the clearance between the opposing surface 411a of the first projecting portion 411 of the first split member 41 and the first axial end surface 51b of the first rolling element 5A is defined as H₁, and the clearance between the opposing surface 412a of the second projecting portion 412 of the first split member 41 and the second axial end surface 51c of the first rolling element 5A is defined as H₂. The clearance H₁ and the clearance H₂ are equal to each other (H₁=H₂). The dimensional relationship described above also applies to the second rolling element 5B, the second split member 42, and the second raceway groove 212.

The first rolling element 5A is relatively movable in accordance with the clearance (C₁+C₂) in the up-down direction formed between the barrel portion 51 and the first raceway groove 211, and the first split member 41 is relatively movable in accordance with the clearance (H₁+H₂) in the up-down direction formed between the first and second projecting portions 411 and 412 and the barrel portion 51 of the first rolling element 5A.

In the embodiment, the distance of relative movement of the first rolling element 5A with respect to the first raceway groove 211 in the up-down direction is restricted to a first predetermined value or less, and the distance of relative movement of the first split member 41 with respect to the first rolling element 5A in the up-down direction is restricted to a second predetermined value or less. That is, the clearance (C₁+C₂) formed between the barrel portion 51 of the first rolling element 5A and the first raceway groove 211 is set to the first predetermined value or less, and the clearance (H₁+H₂) formed between the first and second projecting portions 411 and 412 of the first split member 41 and the barrel portion 51 of the first rolling element 5A is set to the second predetermined value or less.

The first predetermined value may be set to such a value that allows the opposing surfaces 411a and 412a of the first and second projecting portions 411 and 412 to contact the axial end surfaces 51b and 51c, respectively, of the barrel portion 51 of the first rolling element 5A at least when the joint angle is maximized (e.g. 23° to 26°). The second predetermined value may be set to a value corresponding to a clearance that allows the barrel portion 51 of the first rolling element 5A to be smoothly inserted into the first and second raceway grooves 211 and 212 in the center axis direction of the outer ring 2 at least when the roller unit 10 is inserted into the tubular portion 21 of the outer ring 2 during assembly of the constant-velocity joint 1 illustrated in FIG. 1.

In the embodiment, in addition, the first predetermined value described above is set to be smaller than the second predetermined value. That is, the distance of relative movement (C₁+C₂) in the up-down direction allowed for the first rolling element 5A with respect to the first raceway groove 211 is set to be smaller than the distance of relative movement (H₁+H₂) in the up-down direction allowed for the first split member 41 with respect to the first rolling element 5A ((C₁+C₂)<(H₁+H₂)).

Consequently, tilt motion (pitching) of the roller unit 10 illustrated in FIG. 1 with respect to the outer ring 2 in the housing portion 210 in a direction inclined with respect to the rotational axis O₁ (in the direction of the arrow indicated in FIG. 1), which is caused as the clearance (C₁+C₂) in the up-down direction between the first rolling element 5A and the first raceway groove 211 becomes larger, for example, is suppressed.

Next, operation of the constant-velocity joint 1 according to the embodiment at time when the joint angle is maximized will be described with reference to FIG. 6B. When the joint angle is varied to a predetermined angle as in the constant-velocity joint 1 illustrated in FIG. 1 from the state illustrated in FIG. 6A in which the joint angle is 0°, for example, the tripod shaft portion 32 is moved in the up-down direction with respect to the first and second raceway grooves 211 and 212 of the outer ring 2 as the tripod member 3 is rotated eccentrically with respect to the outer ring 2 as discussed earlier. When the joint angle is maximized, the eccentricity of the tripod member 3 with respect to the outer ring 2 is increased, which increases motion of the tripod shaft portion 32 in the up-down direction described above. A case where the joint angle is maximized and the tripod shaft portion 32 has been moved downward (in the direction of the arrow indicated in FIG. 6B) more significantly than during normal use, in which the joint angle is set to a predetermined angle, will be described with reference to FIG. 6B.

The first split member 41 is relatively moved downward with respect to the first rolling element 5A by a predetermined distance (the size of the clearance H₁) along with movement of the head portion 322 of the tripod shaft portion 32. Therefore, the opposing surface 411a of the first projecting portion 411 of the first split member 41 contacts the axial end surface 51b of the first rolling element 5A.

The first axial end surface 51b of the first rolling element 5A is then pushed by the opposing surface 411a of the first projecting portion 411 of the first split member 41 so that the first rolling element 5A is relatively moved downward with respect to the first raceway groove 211 by a predetermined distance (the size of the clearance C₂). After that, the second axial end surface 51c of the barrel portion 51 of the first rolling element 5A contacts the inner side surface 211c of the first raceway groove 211.

Consequently, the first projecting portion 411 of the first split member 41 engages with the barrel portion 51 of the first rolling element 5A so that relative downward movement of the first split member 41 with respect to the first raceway groove 211 of the outer ring 2 is restrained. That is, the amount of relative movement of the first split member 41 with respect to the first raceway groove 211 in the up-down direction is restricted to a predetermined distance. In this event, the first projecting portions 411 and 421 of the first and second split members 41 and 42 are supported by the barrel portions 51 of the first and second rolling elements 5A and 5B along the rotational axis O₁ of the outer ring 2. Thus, tilt motion of the first and second split members 41 and 42 with respect to the first and second raceway grooves 211 and 212 of the outer ring 2 is suppressed.

The same applies to the second rolling element 5B, the second split member 42, and the second raceway groove 212. The first projecting portions 411 and 421 and the second projecting portions 412 and 422 of the first and second split members 41 and 42 correspond to the engagement protrusion according to the present invention.

Consequently, in the embodiment, the first projecting portions 411 and 421 of the first and second split members 41 and 42 are formed as a restraint portion that restrains relative downward movement of the first and second split members 41 and 42, and the inner side surfaces 211c and 212c of the first and second raceway grooves 211 and 212 of the outer ring 2 are formed as a wall surface that restrains downward movement of the first and second rolling elements 5A and 5B in the first and second raceway grooves 211 and 212.

In FIG. 6B, the tripod shaft portion 32 has been moved downward. I In the case where the tripod shaft portion 32 has been moved upward, relative upward movement of the first and second split members 41 and 42 with respect to the first and second raceway grooves 211 and 212 is restricted because of the same principle as that for a case where the tripod shaft portion 32 has been moved downward as discussed above. In this case, the second projecting portions 412 and 422 of the first and second split members 41 and 42 are formed as a restraint portion that restrains relative upward movement of the first and second split members 41 and 42, and the outer side surfaces 211b and 212b of the first and second raceway grooves 211 and 212 of the outer ring 2 are formed as a wall surface that restrains upward movement of the first and second rolling elements 5A and 5B in the first and second raceway grooves 211 and 212.

In the embodiment, the distance between the outer side surface 211b and the inner side surface 211c of the first raceway groove 211 illustrated in FIGS. 6A and 6B is defined as L₁, the axial length of the barrel portion 51 of the first rolling element 5A is defined as L₂, and the distance between the first and second projecting portions 411 and 412 of the first split member 41 is defined as L₃. L₁ may be 10.17 mm, L₂ may be 9.95 mm, and L₃ may be 17.53 mm, for example. Thus, in this case, the distance of relative movement (L₁−L₂) in the up-down direction allowed for the first rolling element 5A with respect to the first raceway groove 211 is 0.22 mm, and the distance of relative movement (L₃−L₂) in the up-down direction allowed for the first split member 41 with respect to the first rolling element 5A is 7.58 mm.

According to the embodiment described above, the following functions and effects can be obtained.

(1) The constant-velocity joint 1 is structured such that the clearance in the up-down direction between the intermediate member 4 and the rolling element 5 and the clearance in the up-down direction between the rolling element 5 and the outer ring 2 is reduced when the intermediate member 4 is moved in the radial direction of the outer ring 2 (in the up-down direction in FIGS. 6A and 6B) with the joint angle maximized. Thus, the distance of relative movement of the intermediate member 4 with respect to the outer ring 2 is restricted to a predetermined distance, which makes it possible to prevent tilt motion of the intermediate member 4 with respect to the outer ring 2. In the case of the constant-velocity joint described in JP 2010-7701 A, for example, the intermediate member may be subjected to tilt motion due to contact between the intermediate member and the neck portion of the tripod shaft portion or the boss portion caused along with swing motion of the tripod shaft portion 32 with the joint angle maximized, so that a load caused along with the tilt motion of the intermediate member described above may be transferred to the cage with the outer surface of the intermediate member contacting the coupling portion of the cage. In contrast, tilt motion of the intermediate member 4 is restrained in the embodiment, so that the load described above is not transferred to the cage. That is, it is possible to suppress deformation of the cage 6 due to a load caused along with tilt motion of the tripod member 3 at the time when the joint angle is maximized.

(2) The distance of relative movement (first predetermined value) of the rolling element 5 with respect to the outer ring 2 is smaller than the distance of relative movement (second predetermined value) of the intermediate member 4 with respect to the rolling element 5. Therefore, it is possible to suppress tilt motion of the roller unit 10 with respect to the outer ring 2 caused as the clearance between the rolling element 5 and the first and second raceway grooves 211 and 212 is increased, for example.

(3) The first split member 41 is formed to have the first projecting portion 411 and the second projecting portion 412. Thus, the first split member 41 is shaped symmetrically in the up-down direction (in the radial direction of the outer ring 2). The second split member 42 is configured similarly. Consequently, it is possible to improve workability during assembly by preventing false recognition during assembly to the intermediate member 4.

(4) The first and second split members 41 and 42 are formed to have the concave surfaces 41a and 42a, respectively, contacted by the outer peripheral surface 322a of the head portion 322 of the tripod shaft portion 32 of the tripod member 3 which is formed in a convex spherical shape. Thus, the first and second split members 41 and 42 and the tripod member 3 spherically contact each other. Consequently, it is possible to increase the area of contact compared to a case where the first and second split members 41 and 42 and the tripod member 3 planarly contact each other, which reduces the load per unit area on the first and second split members 41 and 42 due to the tripod member 3 to extend the life of the roller unit 10.

The sliding constant-velocity joint according to the embodiment has been described above. However, the present invention is not limited to the embodiment, and may be implemented in a variety of aspects without departing from the scope and spirit of the present invention.

The present invention can be modified as appropriate without departing from the scope and spirit of the present invention. For example, the first and second projecting portions 411 and 412 of the first and second split members 41 and 42 are formed to extend in the direction orthogonal to the direction of arrangement of the first and second split members 41 and 42 in the embodiment described above. However, the shape of the first and second projecting portions 411 and 412 is not limited thereto, and the first and second projecting portions 411 and 412 may be partially formed to extend in the direction of arrangement. In this case, it is desirable that the first and second projecting portions 411 and 412 should be formed to be longer than at least the distance between the center axes of the barrel portions 51 of two adjacent rolling elements 5 in order to stabilize the attitude of the intermediate member 4.

In the embodiment, furthermore, the first and second split members 41 and 42 are formed to have the first projecting portions 411 and 421 and the second projecting portions 412 and 422, respectively. However, the present invention is not limited thereto, and the first and second split members 41 and 42 may be formed to have only the first projecting portions 411 and 421, for example. That is, in the case where the joint angle is maximized and when the intermediate member 4 is moved in the up-down direction, in general, the intermediate member 4 is often significantly moved downward. Therefore, relative movement may be restricted at least when the intermediate member 4 is moved downward.

The cage 6 is formed in a rectangular shape with rounded corners. However, the present invention is not limited thereto, and the cage 6 may be formed in the shape of a raceway field in which both end portions in the direction of extension of the first and second raceway grooves 211 and 212 are formed to be semi-circular, for example.

What is claimed is:

1. A sliding constant-velocity joint comprising:
an outer member formed in a tubular shape and having an inner peripheral surface in which a plurality of raceway grooves are formed, the raceway grooves having a pair of raceway surfaces that extend in a center axis direction and face each other;
an inner member having an annular boss portion coupled to an end portion of a shaft that is rotatable at a predetermined joint angle with respect to the outer member, and having a plurality of leg shafts that extend from an outer surface of the boss portion to be inserted into the raceway grooves, the inner member transferring torque between the shaft and the outer member;
an intermediate member disposed between each leg shaft and the pair of raceway surfaces to swingably support the leg shaft;
a plurality of rolling elements disposed between the pair of raceway surfaces and the intermediate member and having a circular columnar barrel portion; and
a cage that holds the plurality of rolling elements such that the rolling elements can circulate along an outer surface of the intermediate member, wherein:
the leg shaft has a head portion that contacts an inner surface of the intermediate member, and has a neck portion formed to be smaller in diameter than the head portion and configured to couple the head portion and the boss portion to each other; and
an amount of movement of the intermediate member in a radial direction of the outer member is restrained such that the intermediate member is not tilted by contact between the intermediate member and the neck portion or the boss portion caused along with swing motion of the leg shaft during rotation of the outer member and the shaft.

2. The sliding constant-velocity joint according to claim 1, wherein:
the plurality of rolling elements are also moved with respect to the outer member in the radial direction in the raceway grooves along with relative movement of the intermediate member;
a distance of movement of the rolling elements with respect to the outer member in the radial direction is restricted to a first predetermined value or less; and
a distance of movement of the intermediate member with respect to the rolling elements in the radial direction is restricted to a second predetermined value or less.

3. The sliding constant-velocity joint according to claim 2, wherein
the first predetermined value is smaller than the second predetermined value.

4. The sliding constant-velocity joint according to claim 3, wherein:
an inner surface of each of the raceway grooves has the raceway surface which serves as a groove bottom surface, an outer side surface positioned on an outer side with respect to the raceway surface in the radial direction of the outer member, and an inner side surface positioned on an inner side with respect to the raceway surface in the radial direction of the outer member; and
the inner side surface is formed as a wall surface that restrains movement of the plurality of rolling elements toward the inner side in the radial direction on the raceway surface.

5. The sliding constant-velocity joint according to claim 4, wherein
the outer side surface is formed as a wall surface that restrains movement of the plurality of rolling elements toward the outer side in the radial direction on the raceway surface.

6. The sliding constant-velocity joint according to claim 4, wherein
a restraint portion that restrains movement of the intermediate member toward the inner side in the radial direction is formed on the outer surface of the intermediate member which opposes the rolling elements.

7. The sliding constant-velocity joint according to claim 6, wherein
a restraint portion that restrains movement of the intermediate member toward the outer side in the radial direction is formed on the outer surface of the intermediate member which opposes the rolling elements.

8. The sliding constant-velocity joint according to claim 6, wherein
the restraint portion is an engagement protrusion that projects from a portion of the outer surface of the intermediate member that opposes the raceway surface to engage with the rolling elements during relative movement of the intermediate member with respect to the outer member.

9. The sliding constant-velocity joint according to claim 1, wherein
the intermediate member has a concave surface that abuts against an outer peripheral surface of the leg shaft; and
an outer surface of the leg shaft is formed in a convex spherical shape to be fitted with the concave surface.
